(19) United States
(12) Patent Application Publication
(10) Pub. No.: US 2009/0232415 A1
(43) Pub. Date: Sep. 17, 2009

(54) PLATFORM FOR THE PRODUCTION OF SEAMLESS ORTHOGRAPHIC IMAGERY

(75) Inventors: Matthew T. Uyttendaele, Seattle, WA (US); Jonathan Ryan Howell, Seattle, WA (US); Jeremy Eric Elson, Kirkland, WA (US); Drew Edward Steedly, Redmond, WA (US); Peter Pesti, Atlanta, GA (US)

Correspondence Address: TUROCY & WATSON, LLP, 127 Public Square, 57th Floor, Key Tower, CLEVELAND, OH, 44114, US

(73) Assignee: MICROSOFT CORPORATION, Redmond, WA (US)

(21) Appl. No.: 12/047,604

(22) Filed: Mar. 13, 2008

(51) Int. Cl. G06K 9/36

(52) U.S. Cl. 382/284

(57) ABSTRACT

Systems and methods are provided for the production of seamless, geo-referenced orthographic images that can comprise a composite of two or more underlying images. Illustratively, an exemplary image processing environment comprises an image processing engine and an instruction set comprising at least one instruction to instruct the image processing engine to process data representative of two or more images. Illustratively, the two or more images can comprise data representative of correspondence points between the two or more images and the underlying area (e.g., ground control points). Illustratively, the exemplary image processing engine can identify features that the overlapping photos have in common (e.g., feature match points) and place and re-project (e.g., distort) each of the two or more images to achieve a selected balance of correct position (e.g., based on ground control points) and seamless overlap (e.g., based on feature match points) which can be composited into a single image.

### BACKGROUND

Collections of aerial photography of the earth have become dramatically more comprehensive and accessible. With current practices, world-wide-web sites that offer comprehensive street maps also supplement these street maps with large databases of aerial photography with resolution rendering street-level features visible. Generally, the aerial photography used by such exemplary web sites is typically orthographic—i.e., visible features in the photo appears as if it is viewed from directly above. Orthographic aerial photography is primarily used because adjacent photographs can be seamlessly joined with each other, giving the user the illusion of viewing a single, large photograph that covers a large area. Modern mapping web sites stitch together many thousands of orthographic aerial photos, allowing users to explore a “virtual photograph” that covers many interesting areas of the world.

With current practices, orthographic aerial photography can be currently mass-produced using costly imaging assets which can be amortized over the large amount of imagery collected. For example, high-altitude imagery can be collected using satellites, and low-altitude imagery using expensive cameras that are specially designed to have tightly controlled lens geometry, aimed with gyroscopic stabilization, integrated with precise GPS for positioning. These expensive features are designed to make it as easy as possible to reconstruct the exact areas of the earth represented by each pixel of each image, making it far easier to stitch the photos together into a seamless orthographic composite.

Mass-produced imagery has the advantage of being comprehensive, but the disadvantage of being generic and targeted for large audiences (e.g., in urban areas) who are willing to buy it. Users on the “heavy tail” of the utility curve often have special-purpose needs not well-met by the collected generic imagery. For example, users might need high quality imagery of a relatively un-populous areas, where it has not been economically worthwhile for the mass-production companies to take images. Further, users might want photography taken at a particular time of year (e.g., to capture a special event), or at a particular time of day.

With current practices, users who want to generate their own custom imagery of an area of interest can acquire images for relatively low costs using low-cost digital cameras. Other capture modalities exist including but not limited to low cost balloon and kite photography projects. However, low-cost cameras typically acquire imagery that is difficult to turn into a seamless, orthographic virtual image of a large area. Low-cost photography typically has very loose constraints regarding, for example, the exact attitude of the camera (i.e., photos are captured from slightly different angles). Also, without high-precision global positioning systems (GPS) coupled to the camera platform, the exact latitude/longitude of the area being imaged every time a frame is acquired is difficult to ascertain. Thus, while individual images are easy to collect, it has thus far been difficult to reconstruct meta-data for the position and orientation of the image being captured by consumer level capture devices (e.g., non-professional digital cameras and camera platforms) rendering difficult the task of stitching captured images in a manner that properly preserves the geographic accuracy of the captured images.

From the foregoing it is appreciated that there exists a need for systems and methods to ameliorate the shortcomings of existing practices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

The herein described systems and methods provide for the production of seamless, geo-referenced orthographic images that operatively can comprise a composite of two or more underlying images that do not rely on the position or orientation of the camera during image acquisition. In an illustrative implementation, an exemplary image processing environment comprises an image processing engine and an instruction set comprising at least one instruction to instruct the image processing engine to process data representative of two or more images to generate a seamless orthogonal image.

In an illustrative operation, the image processing engine receives data representative of two or more images for processing. Illustratively, the two or more images can comprise data representative of correspondence points between the two or more images and the underlying area (e.g., ground control points). In the illustrative operation, the exemplary image processing engine can identify features that the overlapping photos have in common (e.g., feature match points). The exemplary image processing engine can illustratively operate to place and re-project (e.g., distort) each of the two or more images to achieve a selected balance of correct position (e.g., based on ground control points) and seamless overlap (e.g., based on feature match points) to create a stack of images that can contain overlap which can then be composited into a single image. Illustratively, where the images in the stack overlap, the exemplary image processing engine can apply one or more selected techniques to reduce visible seams.

The following description and the annexed drawings set forth in detail certain illustrative aspects of the subject matter. These aspects are indicative, however, of but a few of the various ways in which the subject matter can be employed and the claimed subject matter is intended to include all such aspects and their equivalents.

### BRIEF DESCRIPTION OF THE DRAWINGS

FIG. 1 is a block diagram of one example of an illustrative processing environment in accordance with the herein described systems and methods.

FIG. 2 is a block diagram of exemplary components of an illustrative image processing environment in accordance with the herein described systems and methods.

FIG. 3 is a block diagram of exemplary components of an illustrative image processing environment in accordance with the herein described systems and methods.

FIG. 4 is a block diagram of exemplary images and processing features that can be applied to the exemplary images in accordance with the herein described systems and methods.

FIG. 5 is a block diagram of exemplary images and processing features that can be applied to the exemplary images in accordance with the herein described systems and methods.

FIG. 6 is a flow diagram of one example of an illustrative method performed for image processing to generate seamless orthogonal images.

FIG. 7 is a block diagram of an illustrative computing environment in accordance with the herein described systems and methods.

FIG. 8 is a block diagram of an illustrative networked computing environment in accordance with the herein described systems and methods.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this application, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion.

Additionally, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, the terms “system,” “component,” “module,” “interface,”, “model” or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Although the subject matter described herein may be described in the context of illustrative illustrations to process one or more computing application features/operations for a computing application having user-interactive components the subject matter is not limited to these particular embodiments. Rather, the techniques described herein can be applied to any suitable type of user-interactive component execution management methods, systems, platforms, and/or apparatus.

### Creation of Seamless Orthogonal Composite Images:

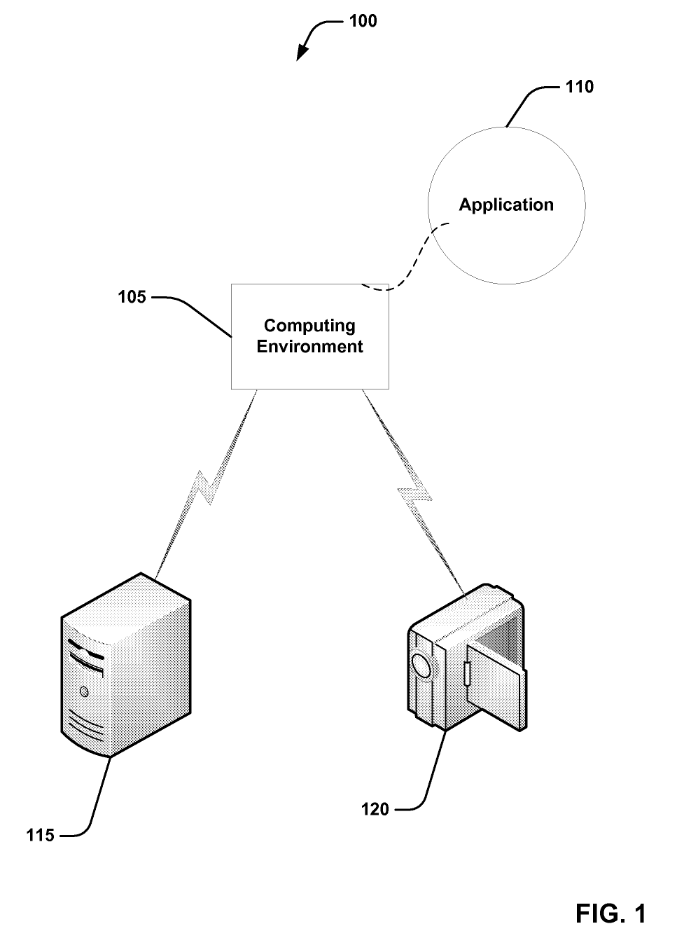

FIG. 1 is a block diagram of exemplary image processing environment 100. As is shown in FIG. 1, image processing environment comprises computing environment 105 operating application 110, cooperating computing environment 115, and image capture device 120. In an illustrative implementation, application 110 can receive data from cooperating computing environment 115 and/or image capture device representative of two or more images. In an illustrative operation, the received two or more images can be processed by application 110 (according to one or more selected image processing techniques and/or operations).

In an illustrative implementation, the images processed by application 110 can be provided by cooperating computing environment 115 cooperating with one or more data stores (not shown) of existing aerial orthogonal images of a desired geographic location. In the illustrative implementation, the data stores can comprise one or more mapping, geo-location data stores as operated by one or more mapping, geo-location, geographical information system service operators.

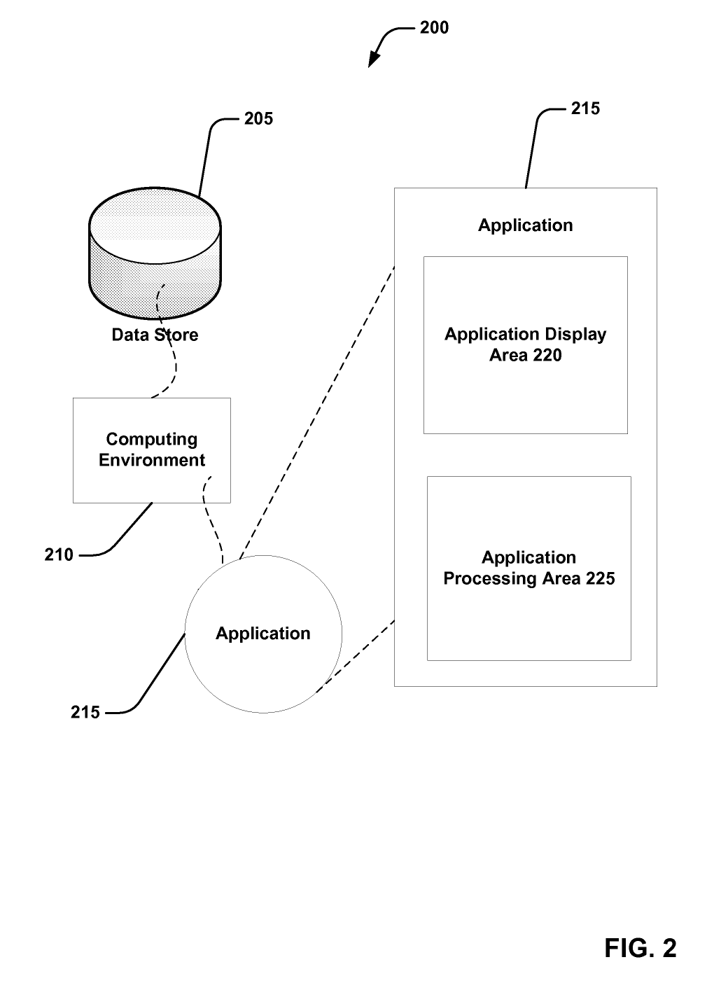

FIG. 2 is a block diagram of exemplary image processing environment 200. As is shown in FIG. 2, exemplary image processing environment 200 comprises computing environment 210 operating application 215 and data store 205. Further, as is shown, computing application 215 further comprises application display area 220 and application processing area 225. In an illustrative implementation, data can be processed by application 215 using application processing area 225 for display, communication, navigation, and/or modification in application display area 220. In an illustrative operation, application 215 can receive data representative of one or more images as provided by data store 205 (or other cooperating electronic environment—not shown—capable of providing electronic data) for processing.

In an illustrative operation, one or more images can be retrieved from data store 205 by application 215 operating on computing environment 210. The retrieved image can be processed in application processing area 225 according to one or more image processing techniques and/or operations for display, communication, navigation, and/or modification in application display area 220. In the illustrative operation, the processed images can comprise orthogonal aerial images of a selected geographic area which can be processed by application 215 to generate one or more seamless orthogonal images.

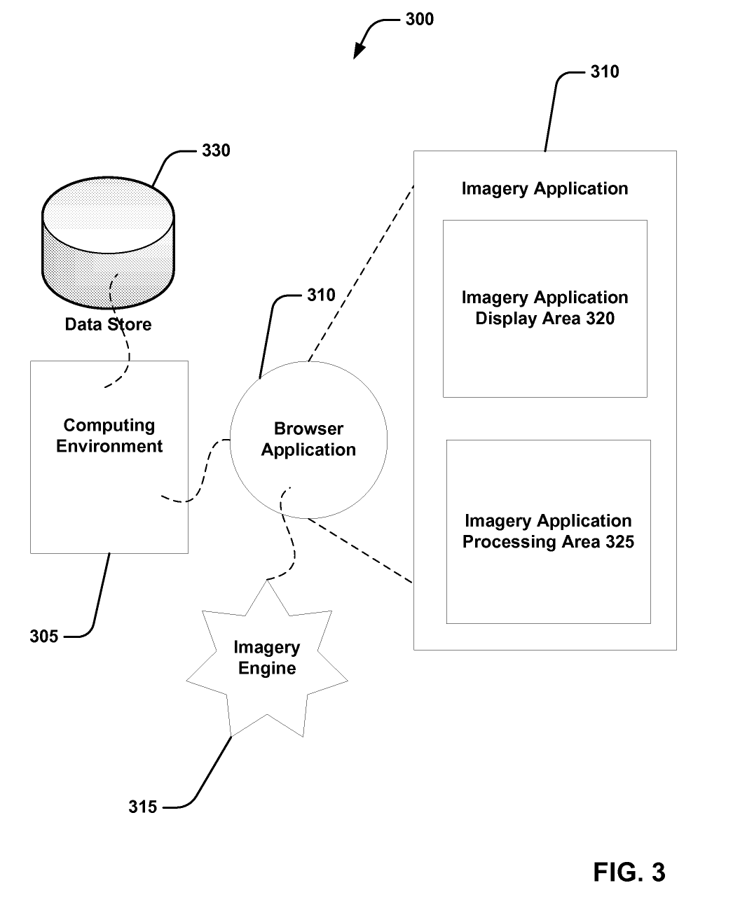

FIG. 3 is a block diagram of exemplary image processing environment 300. As is shown in FIG. 3, exemplary image processing environment 300 comprises computing environment 305 operating application 310 executing imagery engine 315, and data store 330. Further, as is shown, computing application 310 further comprises application display area 320 and application processing area 325. In an illustrative implementation, data can be processed by application 310 executing imagery engine 315 cooperating with application processing area 325 for display, communication, navigation, and/or modification in application display area 320. In an illustrative operation, application 310 can receive data representative of one or more images as provided by data store 330 (or other cooperating electronic environment—not shown—capable of providing electronic data) for processing by imagery engine 315.

In an illustrative operation, one or more images can be retrieved from data store 330 by application 310 operating on computing environment 305. The retrieved image can be processed by imagery engine 315 cooperating with application processing area 325 according to one or more image processing techniques and/or operations for display, communication, navigation, and/or modification in application display area 320. In the illustrative operation, the processed images can comprise orthogonal aerial images of a selected geographic area which can be processed by application 310 to generate one or more seamless orthogonal images. In the illustrative implementation, imagery engine 315 can comprise one or more instructions to identify ground control points in the images being processed to decipher overlapping regions within the images and process the images using the ground control points to generate one or more composite images of the underlying retrieved images. Further, in the illustrative implementation, imagery engine 315 can comprise one or more instructions to reduce visible seams of the generated one or more composite images.

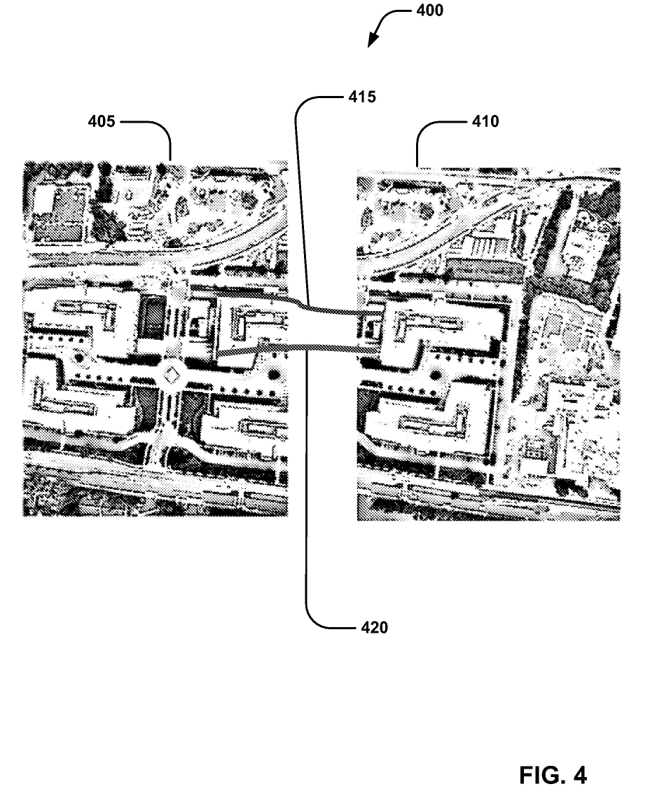

FIG. 4 schematically illustrates exemplary image data 400 representative of images that can be provided as input to an exemplary image processing engine (e.g., imagery engine 315 of FIG. 3). As is shown, illustratively image data 400 comprises a first image 405 and second image 410. Image 405 comprises an aerial view of a desired geographic location. Image 410 comprises an aerial view of the same general geographic location as captured in image 405 but shot from a slightly different location. Further, as is shown by indicator lines 415 and 420, an exemplary imagery engine can process images 405 and 410 to identify correspondence points which indicate common features of the images for use when generating one or more composite images from images 405 and 410.

In an illustrative implementation, images 405 and 410 can be captured by a consumer level (or professional type) image capture device. The geographic location captured by the image can be correlated using one or more secondary data representative of geographic coordinate positions to better correlate correspondence points in images 405 and 410. Such secondary data can comprise map data, global positioning system data, and landmark data.

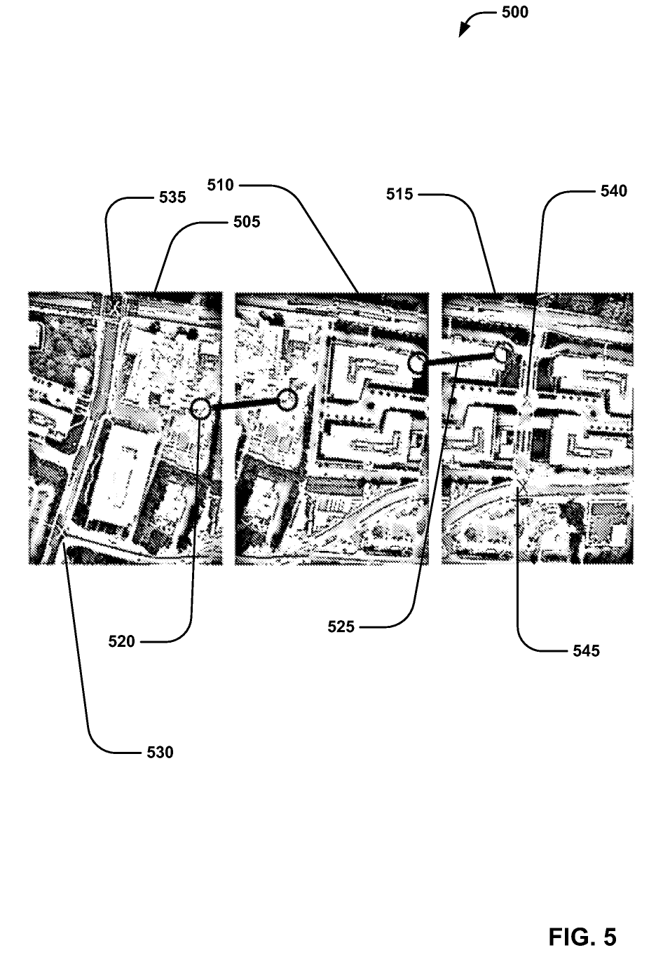

FIG. 5 is a block figure of data 500 that can be processed by an exemplary imagery engine (e.g., 315 of FIG. 3) to generate seamless orthogonal images from underlying image data. As is shown data 500 comprises first image 505, second image 510, and third image 515. Additionally, as is shown in FIG. 5, data 500 can comprise data representative of feature matches 520 and 525 as they exist among images 505, 510, and 515 respectively. In an illustrative operation, an exemplary imagery engine can be operable to execute one or more algorithms to identify matched features (e.g., feature matcher) among input images. In the illustrative operation, an exemplary feature-matcher can be run on the images 505, 510, and 515 to generate two correspondences 520 and 525 respectively. In the illustrative operation, data representative of correspondence points (e.g., ground control points) 530, 535, 540, and 545 can be received (e.g., inputted by a participating user) for images 505 and 510. In an illustrative implementation, ground control points 530, 535, 540, and 545 can be matched to absolute earth coordinates (e.g., secondary data points). Using absolute earth coordinates, approximate camera parameters can be determined for images 505 and 515. Illustratively, these camera parameters can be used to estimate the earth coordinates of other points for images 505 and 515—including the feature match points indicated by indicator lines 520 and 525. In the illustrative operation, exemplary imagery engine can create other correspondence points by approximation using the inputted secondary data.

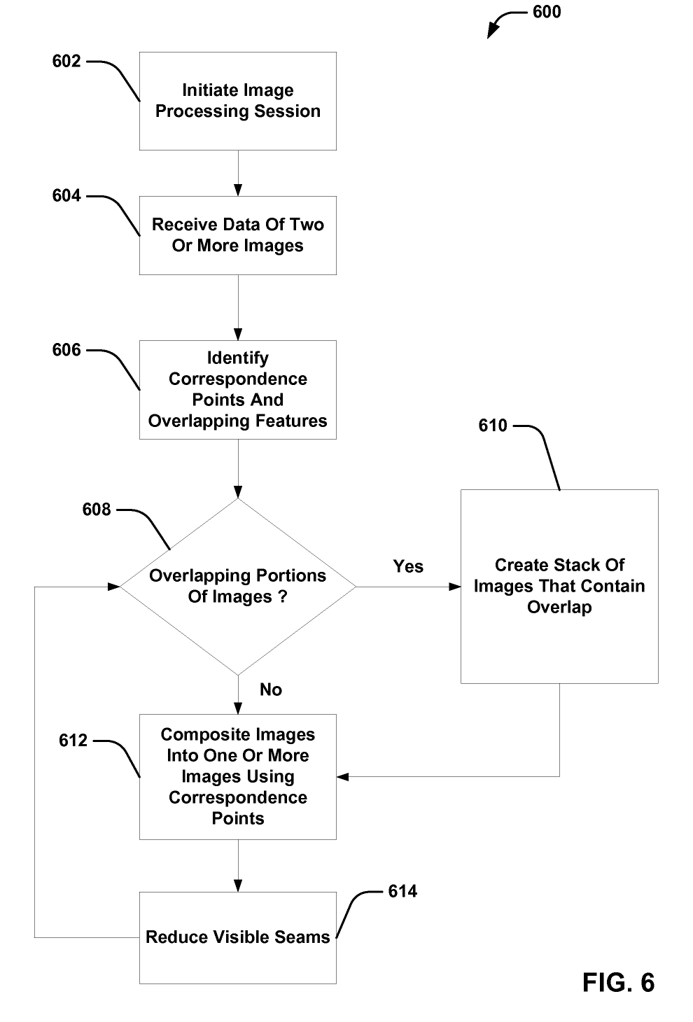

FIG. 6 is a flow diagram of one exemplary method 600 for processing image data to generate seamless orthogonal images. As is shown, processing begins at block 602 where an image processing session is initiated. Processing then proceeds to block 604 where data of two or more images is received (e.g., by an exemplary imagery engine). Correspondence points are then identified as well as overlapping features at block 606. A check is then performed at block 608 to determine overlapping portions of the images. If the check at block 608 indicates there are overlapping portions of images, processing proceeds to block 610 where a stack of the images that contain the overlap are created. Processing then proceeds to block 612 where one or more composite images are generated using the correspondence points. Visible seams are then reduced at block 614.

However, if at block 608 it is determined that there are no overlapping portions of the input images, processing proceeds to block 612 and processing proceeds from there.

In an illustrative operation, correspondence point information about the two or more input images can be combined with feature match points to determine how each image should be re-projected (distorted) and positioned to ensure the best mix of 1) orthographic re-projection—distorting the image so it looks like it was taken straight-down, removing perspective distortion introduced as the camera is most likely being held at a slight angle, 2) geographic correctness—determining the extent of each image according to global coordinates (latitude and longitude), and 3) alignment of the edges of overlapping images with each other, so that seams between them are less visible. Illustratively, the images can be modeled as being taken by a separate camera, and model each camera as having: a) a focal length (zoom), b) a position in 3-dimensional space (e.g., lat/lon projected into the conformal Mercator projection), and c) a rotation in 3 dimensions.

The methods can be implemented by computer-executable instructions stored on one or more computer-readable media or conveyed by a signal of any suitable type. The methods can be implemented at least in part manually. The steps of the methods can be implemented by software or combinations of software and hardware and in any of the ways described above. The computer-executable instructions can be the same process executing on a single or a plurality of microprocessors or multiple processes executing on a single or a plurality of microprocessors. The methods can be repeated any number of times as needed and the steps of the methods can be performed in any suitable order.

The subject matter described herein can operate in the general context of computer-executable instructions, such as program modules, executed by one or more components. Generally, program modules include routines, programs, objects, data structures, etc., that perform particular tasks or implement particular abstract data types. Typically, the functionality of the program modules can be combined or distributed as desired. Although the description above relates generally to computer-executable instructions of a computer program that runs on a computer and/or computers, the user interfaces, methods and systems also can be implemented in combination with other program modules. Generally, program modules include routines, programs, components, data structures, etc. that perform particular tasks and/or implement particular abstract data types.

Moreover, the subject matter described herein can be practiced with most any suitable computer system configurations, including single-processor or multiprocessor computer systems, mini-computing devices, mainframe computers, personal computers, stand-alone computers, hand-held computing devices, wearable computing devices, microprocessor-based or programmable consumer electronics, and the like as well as distributed computing environments in which tasks are performed by remote processing devices that are linked through a communications network. In a distributed computing environment, program modules can be located in both local and remote memory storage devices. The methods and systems described herein can be embodied on a computer-readable medium having computer-executable instructions as well as signals (e.g., electronic signals) manufactured to transmit such information, for instance, on a network.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing some of the claims.

It is, of course, not possible to describe every conceivable combination of components or methodologies that fall within the claimed subject matter, and many further combinations and permutations of the subject matter are possible. While a particular feature may have been disclosed with respect to only one of several implementations, such feature can be combined with one or more other features of the other implementations of the subject matter as may be desired and advantageous for any given or particular application.

Moreover, it is to be appreciated that various aspects as described herein can be implemented on portable computing devices (e.g., field medical device), and other aspects can be implemented across distributed computing platforms (e.g., remote medicine, or research applications). Likewise, various aspects as described herein can be implemented as a set of services (e.g., modeling, predicting, analytics, etc.).

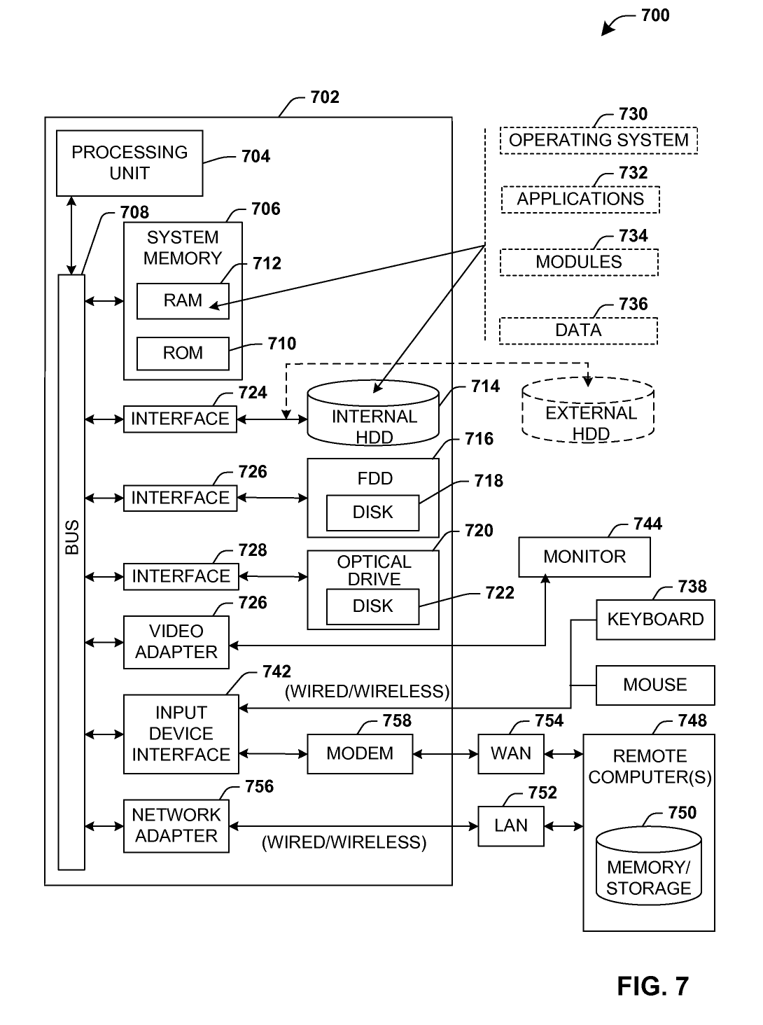

FIG. 7 illustrates a block diagram of a computer operable to execute the disclosed architecture. In order to provide additional context for various aspects of the subject specification, FIG. 7 and the following discussion are intended to provide a brief, general description of a suitable computing environment 700 in which the various aspects of the specification can be implemented. While the specification has been described above in the general context of computer-executable instructions that may run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification may also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

More particularly, and referring to FIG. 7, an example environment 700 for implementing various aspects as described in the specification includes a computer 702, the computer 702 including a processing unit 704, a system memory 706 and a system bus 708. The system bus 708 couples system components including, but not limited to, the system memory 706 to the processing unit 704. The processing unit 704 can be any of various commercially available processors. Dual microprocessors and other multi-processor architectures may also be employed as the processing unit 704.

The system bus 708 can be any of several types of bus structure that may further interconnect to a memory bus (with or without a memory controller), a peripheral bus, and a local bus using any of a variety of commercially available bus architectures. The system memory 706 includes read-only memory (ROM) 710 and random access memory (RAM) 712. A basic input/output system (BIOS) is stored in a non-volatile memory 710 such as ROM, EPROM, EEPROM, which BIOS contains the basic routines that help to transfer information between elements within the computer 702, such as during start-up. The RAM 712 can also include a high-speed RAM such as static RAM for caching data.

The computer 702 further includes an internal hard disk drive (HDD) 714 (e.g., EIDE, SATA), which internal hard disk drive 714 may also be configured for external use in a suitable chassis (not shown), a magnetic floppy disk drive (FDD) 716, (e.g., to read from or write to a removable diskette 718) and an optical disk drive 720, (e.g., reading a CD-ROM disk 722 or, to read from or write to other high capacity optical media such as the DVD). The hard disk drive 714, magnetic disk drive 716 and optical disk drive 720 can be connected to the system bus 708 by a hard disk drive interface 724, a magnetic disk drive interface 726 and an optical drive interface 728, respectively. The interface 724 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 702, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the example operating environment, and further, that any such media may contain computer-executable instructions for performing the methods of the specification.

A number of program modules can be stored in the drives and RAM 712, including an operating system 730, one or more application programs 732, other program modules 734 and program data 736. All or portions of the operating system, applications, modules, and/or data can also be cached in the RAM 712. It is appreciated that the specification can be implemented with various commercially available operating systems or combinations of operating systems.

A user can enter commands and information into the computer 702 through one or more wired/wireless input devices, e.g., a keyboard 738 and a pointing device, such as a mouse 740. Other input devices (not shown) may include a microphone, an IR remote control, a joystick, a game pad, a stylus pen, touch screen, or the like. These and other input devices are often connected to the processing unit 704 through an input device interface 742 that is coupled to the system bus 708, but can be connected by other interfaces, such as a parallel port, an IEEE 1394 serial port, a game port, a USB port, an IR interface, etc.

A monitor 744 or other type of display device is also connected to the system bus 708 via an interface, such as a video adapter 746. In addition to the monitor 744, a computer typically includes other peripheral output devices (not shown), such as speakers, printers, etc.

The computer 702 may operate in a networked environment using logical connections via wired and/or wireless communications to one or more remote computers, such as a remote computer(s) 748. The remote computer(s) 748 can be a workstation, a server computer, a router, a personal computer, portable computer, microprocessor-based entertainment appliance, a peer device or other common network node, and typically includes many or all of the elements described relative to the computer 702, although, for purposes of brevity, only a memory/storage device 750 is illustrated. The logical connections depicted include wired/wireless connectivity to a local area network (LAN) 752 and/or larger networks, e.g., a wide area network (WAN) 754. Such LAN and WAN networking environments are commonplace in offices and companies, and facilitate enterprise-wide computer networks, such as intranets, all of which may connect to a global communications network, e.g., the Internet.

When used in a LAN networking environment, the computer 702 is connected to the local network 752 through a wired and/or wireless communication network interface or adapter 756. The adapter 756 may facilitate wired or wireless communication to the LAN 752, which may also include a wireless access point disposed thereon for communicating with the wireless adapter 756.

When used in a WAN networking environment, the computer 702 can include a modem 758, or is connected to a communications server on the WAN 754, or has other means for establishing communications over the WAN 754, such as by way of the Internet. The modem 758, which can be internal or external and a wired or wireless device, is connected to the system bus 708 via the serial port interface 742. In a networked environment, program modules depicted relative to the computer 702, or portions thereof, can be stored in the remote memory/storage device 750. It will be appreciated that the network connections shown are example and other means of establishing a communications link between the computers can be used.

The computer 702 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

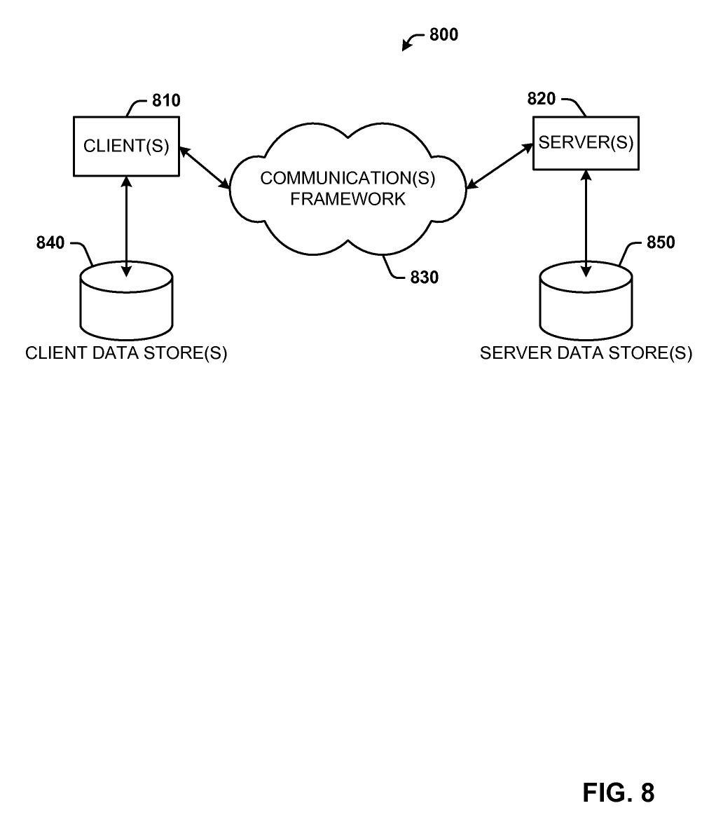

Referring now to FIG. 8, there is illustrated a schematic block diagram of an exemplary computing environment 800 in accordance with the subject invention. The system 800 includes one or more client(s) 810. The client(s) 810 can be hardware and/or software (e.g., threads, processes, computing devices). The client(s) 810 can house cookie(s) and/or associated contextual information by employing the subject invention, for example. The system 800 also includes one or more server(s) 820. The server(s) 820 can also be hardware and/or software (e.g., threads, processes, computing devices). The servers 820 can house threads to perform transformations by employing the subject methods and/or systems for example. One possible communication between a client 810 and a server 820 can be in the form of a data packet adapted to be transmitted between two or more computer processes. The data packet may include a cookie and/or associated contextual information, for example. The system 800 includes a communication framework 830 (e.g., a global communication network such as the Internet) that can be employed to facilitate communications between the client(s) 810 and the server(s) 820.

Communications can be facilitated via a wired (including optical fiber) and/or wireless technology. The client(s) 810 are operatively connected to one or more client data store(s) 840 that can be employed to store information local to the client(s) 810 (e.g., cookie(s) and/or associated contextual information). Similarly, the server(s) 820 are operatively connected to one or more server data store(s) 850 that can be employed to store information local to the servers 820.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system allowing the generation of seamless orthogonal images, comprising:
an imagery engine operative to receive data representative of two or more images;
an instruction set comprising at least one instruction to instruct the imagery engine to process the data according to a selected image processing paradigm,
wherein the selected image processing paradigm employs correspondence points and overlapping features among the two or more images to identify one or more overlapping image portions used to create one or more composite images of the two or more received images.

2. The system as recited in claim 1, further comprising a data store operatively coupled to the imager engine comprising data representative of one or more images.

3. The system as recited in claim 1, wherein the two or more images comprise data of true geographic coordinates.

4. The system as recited in claim 3, wherein the true geographic coordinates are deployed by the imagery engine during image processing to generate one or more correspondence points.

5. The system as recited in claim 1, wherein the correspondence points are received by the imager engine as input from participating user.

6. The system as recited in claim 1, wherein the image processing paradigm comprises one or more instructions to reduce visible seams.

7. The system as recited in claim 6, wherein the imagery engine is operative to reduce visible seams by automatic feature matching between the overlapping portions of the two or more images.

8. The system as recited in claim 6, wherein the imagery engine is operative to reduce visible seams by balancing/normalizing color among the two or more images.

9. The system as recited in claim 6, wherein the imagery engine is operative to reduce visible seams by identifying a selected visible feature among the two or more images.

10. The system as recited in claim 1, wherein the one or more composite images are produces as image tiles.

11. A method to generate seamless orthogonal images comprising:
receiving data representative of two or more images;
identifying one or more correspondence points among the two or more images;
identifying one or more feature matches among the two or more images; and
generating one or more composite images using the identified correspondence points and feature map data.

12. The method as recited in claim 11, further comprising applying one or more techniques to reduce visible seams in the generated one or more composite images.

13. The method as recited in claim 11, further comprising receiving data representative of correspondence points regarding the two or more images.

14. The method as recited in claim 11, further comprising generating one or more composite images as image tiles.

15. The method as recited in claim 11, further comprising re-projecting the two or more images into one or more composite image using the identified one or more correspondence points and one or more feature matches.

16. The method as recited in claim 11, further comprising generating other correspondence points based on identified correspondence points.

17. The method as recited in claim 11, further comprising receiving geo-referenced data regarding the two or more images.

18. The method as recited in claim 17, further comprising processing the received geo-referenced data in combination with the identified correspondence points and feature matches to generate the one or more composite images.

19. The method as recited in claim 11, further comprising trimming the two or more images to generate the one or more composite images.

20. A computer-readable medium having computer executable instructions to instruct a computing environment to perform a method comprising:
receiving data representative of two or more images;
identifying one or more correspondence points among the two or more images;
identifying one or more feature matches among the two or more images; and
generating one or more composite images using the identified correspondence points and feature map data.
